(19) United States
(12) Patent Application Publication
(10) Pub. No.: US 2013/0226752 A1
(43) Pub. Date: Aug. 29, 2013

(54) METHOD FOR CALCULATING BILL FOR USE OF WATER PURIFICATION SYSTEM AND WATER PURIFICATION SYSTEM

(71) Applicant: Tokyo Electron Limited, (US)

(72) Inventors: Tsuyoshi Moriya, Minato-ku (JP); Kenichi Kataoka, Nirasaki-shi (JP); Shigeru Senzaki, Kurokawa-gun (JP); Youichi Shimanuki, Nirasaki-shi (JP); Kazuhiko Kano, Fuchu-shi (JP)

(73) Assignee: Tokyo Electron Limited, Minato-ku (JP)

(21) Appl. No.: 13/861,657

(22) Filed: Apr. 12, 2013

Related U.S. Application Data
(63) Continuation of application No. PCT/JP2011/073749, filed on Oct. 7, 2011.

(30) Foreign Application Priority Data
Oct. 14, 2010 (JP) 2010-231574

(51) Int. Cl. G06Q 30/04

(52) U.S. Cl. CPC G06Q 30/04
USPC 705/34; 705/400

(57) ABSTRACT

To provide a billing method for use of a water purification system that gives incentives for using the water purification system. Such a water purification system is equipped with water purification apparatus having controller and with monitoring server connected to water purification apparatus via public network and having controller. Filtration filter of water purification apparatus has water quality sensor, which measures water quality data of inflow water, and water quality sensor, which measures water quality data of purified water. Water quality data measured by water quality sensors are transmitted to controller and controller. Usage fees for the water purification system are calculated corresponding to improvement rates of water quality, which are calculated based on water quality data of inflow water and water quality data of purified water.

### CROSS-REFERENCE TO RELATED APPLICATIONS

This application is a continuation of International Application No. PCT/JP2011/073749, filed Oct. 7, 2011, which is based upon and claims the benefit of priority from Japanese Patent Application No. 2010-231574, filed Oct. 14, 2010. The entire contents of these applications are incorporated herein by reference.

### BACKGROUND OF THE INVENTION

1. Field of the Invention

The present invention relates to a billing method for use of a water purification system.

2. Description of Background Art

Filtration filters are often used in water purification systems to produce clean water from wastewater (sewage) from factories and households by removing pollutants and contaminants or to produce fresh water from seawater by removing salt content or the like. As for filtration filters, reverse osmosis membranes made of polymeric material are known (see Japanese Laid-Open Patent Publication H05-15750, for example). The entire contents of this publication are incorporated herein by reference. A reverse osmosis membrane has numerous penetrating holes with a diameter of a few nanometers. When pressure is added to sewage or seawater to make it flow through such penetrating holes, contaminant molecules the size of a few nanometers and hydrated sodium ions surrounded by water molecules cannot pass through the penetrating holes, while water molecules each with an approximate diameter of 0.38 nm can pass though the penetrating holes. Accordingly, the reverse osmosis membrane produces clean water or fresh water from sewage or seawater by separating water molecules from contaminants or salt content.

As general consumers have become more conscious of health and safety issues in recent years, users of water purification systems are showing greater concern regarding the quality of purified water. In addition, the required quality of purified water differs among users. On the other hand, the quality of purified water in a water purification system may decrease because reverse osmosis membranes become decayed by bacteria contained in sewage flowing into the water purification system during long periods of use, or because the penetrating holes are enlarged due to damage from backwashing or the like.

### SUMMARY OF THE INVENTION

According to one aspect of the present invention, a billing method for use of a water purification system which is equipped at least with a water purification apparatus, a control apparatus and a water quality sensor includes the control apparatus which performs a combining step for selecting and combining at least one or more purification processes among multiple purification processes based on the difference between the quality of water flowing into the water purification apparatus and the quality of purified water supplied by the water purification apparatus, and a billing step for billing based on the processes combined in the combining step.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a view to illustrate a circumstance where the billing method for use of a water purification system is implemented according to an embodiment of the present invention;

FIG. 2 is a view to illustrate the structure of a water purification system according to an embodiment of the present invention;

FIG. 3A is a view of a step in an example of a method for manufacturing a filtration filter built into the main body of the water purification apparatus shown in FIG. 2, showing a substrate where DTs (deep trenches) are formed;

FIG. 3B is a view of a step in an example of a method for manufacturing a filtration filter built into the main body of the water purification apparatus shown in FIG. 2, showing a substrate where a silicon-oxide membrane is deposited on inner surfaces of the DTs;

FIG. 3C is a view of a step in an example of a method for manufacturing a filtration filter built into the main body of the water purification apparatus shown in FIG. 2, showing a filtration filter made of a substrate through which numerous DTs penetrate;

FIG. 4 is a flowchart showing a water quality data communication process to be performed in the water purification system shown in FIG. 2;

FIG. 5 is a flowchart showing a process to be performed for reporting abnormality in water quality in the water purification system shown in FIG. 2;

FIG. 6 is a flowchart of a modified example showing a process to be performed for reporting abnormality in water quality in the water purification system shown in FIG. 2;

FIG. 7 is a flowchart showing a restoration process to be performed on the water purification apparatus in the water purification system shown in FIG. 2;

FIG. 8 is a flowchart of a modified example showing a restoration process to be performed on the water purification apparatus in the water purification system shown in FIG. 2;

FIG. 9 is a flowchart showing a process to be performed for forecasting abnormality in water quality in the water purification system shown in FIG. 2;

FIG. 10 is a flowchart of a modified example showing a process to be performed for forecasting abnormality in water quality in the water purification system shown in FIG. 2;

FIG. 11 is a flowchart showing a billing process based on usage of the water purification system shown in FIG. 2; and

FIG. 12 is a flowchart showing a billing process based on the workload on the water purification system shown in FIG. 2.

### DETAILED DESCRIPTION OF THE EMBODIMENTS

The embodiments will now be described with reference to the accompanying drawings, wherein like reference numerals designate corresponding or identical elements throughout the various drawings.

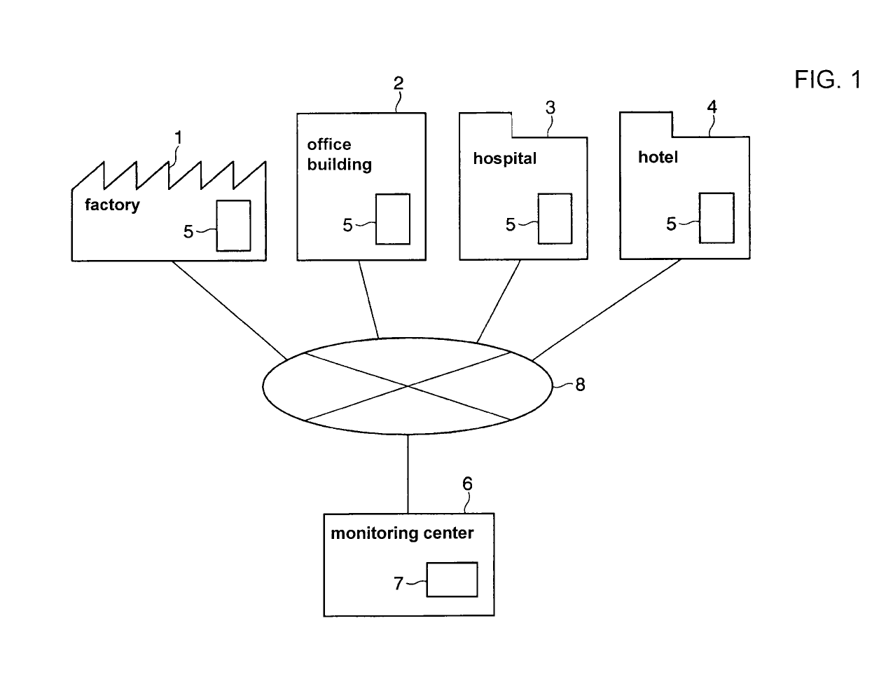

FIG. 1 is a view illustrating a circumstance for implementing the billing method for use of a water purification system according to the present embodiment.

In FIG. 1, water purification apparatus 5 is installed in factory 1, office building 2, hospital 3 and hotel 4 where users of the water purification system work or use services. Also, monitoring server 7 (monitoring apparatus) is equipped in monitoring center 6 where the provider or monitoring personnel of the water purification system work. Factory 1, office building 2, hospital 3 and hotel 4 are each connected to monitoring center 6 via public network 8 and conduct data communication with monitoring server 7 of monitoring center 6.

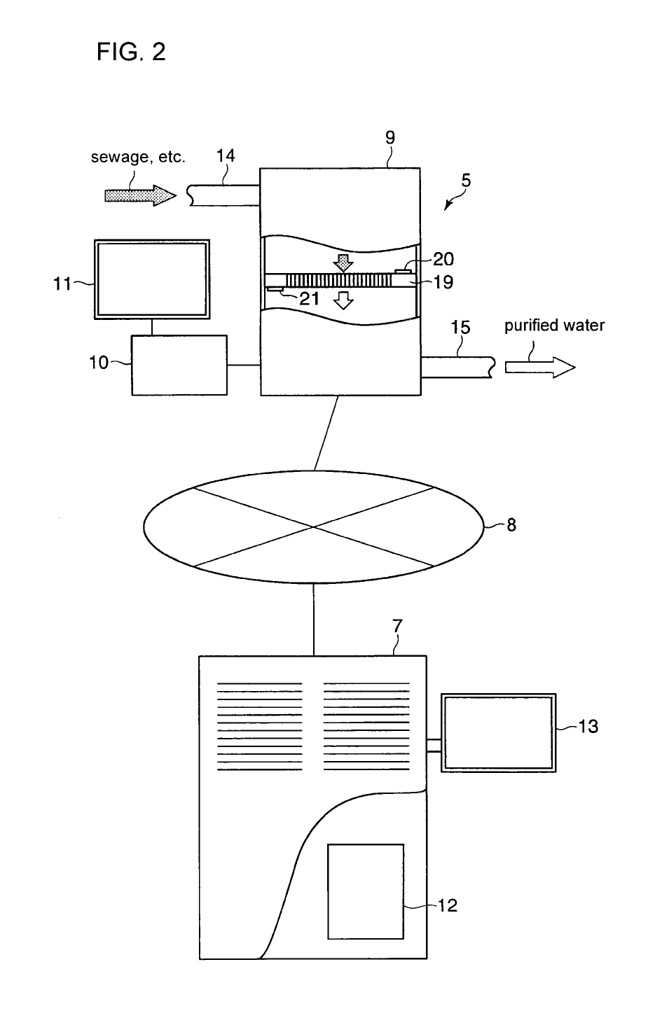

FIG. 2 is a view illustrating the structure of a water purification system according to the present embodiment.

In FIG. 2, the water purification system is equipped with water purification apparatus 5, monitoring server 7 and public network 8; water purification apparatus 5 includes main body 9 having later-described built-in filtration filter 19, controller 10 (control apparatus) connected to main body 9, and display 11 connected to controller 10; and monitoring server 7 has controller 12 (control apparatus) and display 13.

Main body 9 of water purification apparatus 5 includes filtration filter 19, inflow port 14 through which sewage or seawater flows into main body 9, and outlet 15 through which purified water purified by filtration filter 19 flows out of main body 9.

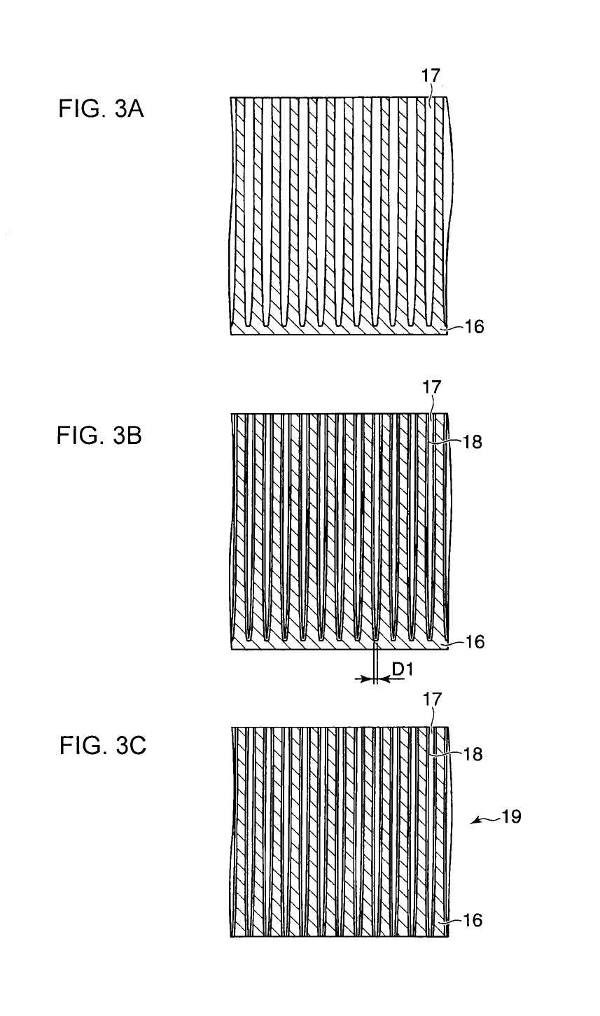

FIGS. 3A to 3C are views showing steps in an example of a method for manufacturing filtration filter 19 built into the main body of the water purification apparatus shown in FIG. 2. FIG. 3A is a view showing substrate 16 where DTs (deep trenches) 17 are formed, FIG. 3B is a view showing substrate 16 where silicon-oxide membrane 18 is deposited on inner surfaces of DTs 17, and FIG. 3C is a view showing filtration filter 19 made of substrate 16 through which numerous DTs 17 penetrate.

First, in FIGS. 3A to 3C, numerous DTs 17 are formed by etching silicon substrate 16 using a masking film. In the present embodiment, numerous DTs 17 with an approximate width of 20 nm˜40 nm are formed in substrate 16 (FIG. 3A). Usually, in DTs with an aspect ratio of 10 or greater, their tip portions become narrower and the width of the tip portions of DTs 17 is approximately 10 nm, for example.

Next, silicon-oxide membrane 18 is deposited on the surfaces of substrate 16 and inner surfaces of DTs 17 through ALD (atomic layer deposition) (FIG. 3B). In the present embodiment, the processing time of ALD is adjusted so that the minimum width (D1) at the tip portions of DTs 17 is set at 1 nm˜10 nm, more preferably at 1 nm˜2 nm.

Next, a lower surface of substrate 16 is polished by CMP or the like, and such polishing is stopped when the tip portions of DTs 17 are exposed at the lower surface of substrate 16. In doing so, filtration filter 19 is formed by penetrating each DT 17 through substrate 16 (FIG. 3C). Accordingly, the present process is completed.

In filtration filter 19, minimum width (D1) of DTs 17 penetrating through substrate 16 is set at 1 nm˜10 nm. Thus, when sewage or seawater flows through DTs 17, not only contaminants and salt content but also picornaviruses or parvoviruses with an approximate size of 20 nm are also removed. Therefore, water purification apparatus 5 can purify sewage or the like flowing into inflow port 14 and can supply purified water through outlet 15.

When the filtering target to be filtered through filtration filter 19 is limited to being relatively large, for example, limited to vibrio cholera or typhoid bacillus with sizes of a few hundred nanometers, minimum width (D1) above may be in an approximate range of 1 nm˜100 nm. Accordingly, the width before ALD of the tip portions of DTs 17 formed in substrate 16 by etching may also be set at 100 nm˜1 μm, for example.

In FIG. 2 again, water quality sensors (20, 21) are provided for filtration filter 19, which are formed respectively on an upstream side surface (upper surface) and a downstream side surface (lower surface) of sewage or the like flowing in main body 9. Water quality sensors (20, 21) are made of IC chips. As described above, filtration filter 19 includes substrate 16 made of silicon. Water quality sensors (20, 21) may be positioned directly on substrate 16 by processing the upper and lower surfaces of substrate 16 so that water quality sensors (20, 21) are prevented from being removed from filtration filter 19 by the flow of sewage or the like.

Water quality sensor 20 measures data with regard to the water quality of sewage or the like flowing in main body 9 (hereinafter, simply referred to as “water quality data”), then transmits the measured water quality data to controller 10. Water quality sensor 21 measures the water quality data of purified water flowing in main body 9, then transmits the water quality data to controller 10.

Physical indicators of water quality data measured by water quality sensors (20, 21) are as follows, for example: residual chloride content, chromaticity, clarity, turbidity, pH value, temperature, pressure value, dissolved oxygen amount, electrical conductivity, electrical resistivity, salt content, total dissolved solids, relative density of seawater, oxidation-reduction potential, and various ion concentrations (such as nitrite ion concentration, chloride ion concentration, calcium ion concentration, fluoride ion concentration, potassium ion concentration and ammonium ion concentration).

Water quality sensor 20 or the like determines clarity by measuring the amount of penetrated laser light, and determines turbidity by measuring the amount of scattered laser light, when the water in main body 9 is irradiated by laser beams from the outside through a window (not shown in the drawings), for example. Also, water quality sensor 20 or the like determines electrical resistivity by measuring electrical current or the like flowing in the water in main body 9. Generally speaking, since electrical resistivity increases when more organic components are present in the water, organic contamination levels may be measured based on electrical resistivity.

Regarding other physical indicators, they may be measured by generally known measuring methods. Any physical indicator is obtained by measuring a unit amount of continuously flowing water (inflow water, purified water). Therefore, when water quality data are shown, they may be on a curved continuous line that shows changes in measured values obtained as a result of continuously measuring a unit amount of water, or on intermittent plot values obtained as a result of measuring every predetermined amount of a unit amount of water. Also, the numerical values of water quality data may be average values of predetermined amounts of water or average values during predetermined periods of time. Alternatively, generally used statistical methods or the like may also be used for calculation.

Controller 10 converts transmitted water quality data into a specific format and transmits the data to controller 12 of monitoring server 7, while receiving water quality data or commands transmitted from controller 12. In addition, controller 10 controls what to display on display 11, and further controls the operation of restoration mechanisms of filtration filter 19 in water purification apparatus 5.

As for restoration mechanisms for filtration filter 19, listed are a reverse-flow mechanism which reverses the flow of water from the lower-surface side to the upper-surface side of filtration filter 19 in main body 9, and an oscillating mechanism which provides oscillation for filtration filter 19 using ultrasound waves or the like. Moreover, if filtration filter 19 is coated with titanium oxide, an irradiating mechanism is used to irradiate ultraviolet rays on filtration filter 19. The reverse-flow mechanism flushes contaminants clogged in DTs 17 of filtration filter 19 by reversing the water flow in main body 9, and the oscillating mechanism applies oscillation to filtration filter 19 so that contaminants attached to inner surfaces of each DT 17 are removed from inside DT 17. Also, the irradiating mechanism removes contaminants attached to filtration filter 19 through self-cleansing actions of a photocatalyst when ultraviolet rays are irradiated on filtration filter 19.

Display 11 displays the water quality data measured by water quality sensor 20 or the like, abnormality details in water purification apparatus 5, or a forecast as to when abnormality may occur in water purification apparatus 5, as described later.

Controller 12 of monitoring server 7 receives water quality data in a specific format transmitted from controller 10 of water purification apparatus 5, stores the data in a database (not shown in the drawings), then transmits to controller 10 details of abnormality in water purification apparatus 5, restoration processes to be performed on filtration filter 19, and a forecast as to when abnormality may occur in water purification apparatus 5, which are determined based on the received water quality data. Controller 12 controls what to display on display 13.

Display 13 displays water quality data measured by water quality sensor 20 or the like, abnormality details in water purification apparatus 5, or a forecast as to when abnormality may occur in water purification apparatus 5, as described later. In addition, display 13 is a touch-panel display and accepts input from monitoring personnel.

In the present embodiment, water purification apparatus 5 has one main body 9. However, it may include multiple main bodies 9, and the usage of purified water may be set different for each main body 9 according to the quality of purified water supplied from outlet 15 of each main body 9.

Main body 9 is equipped with filtration filter 19. However, instead of using filtration filter 19, supercritical water or subcritical water may be supplied to main body 9 to decompose organic components in the water into gas, liquid and/or fine amino acids through organic decomposition action using the supercritical water or subcritical water. In such a case, water quality sensors are preferred to be positioned at inflow port 14 and outlet 15.

Next, various processes performed in the water purification system are described.

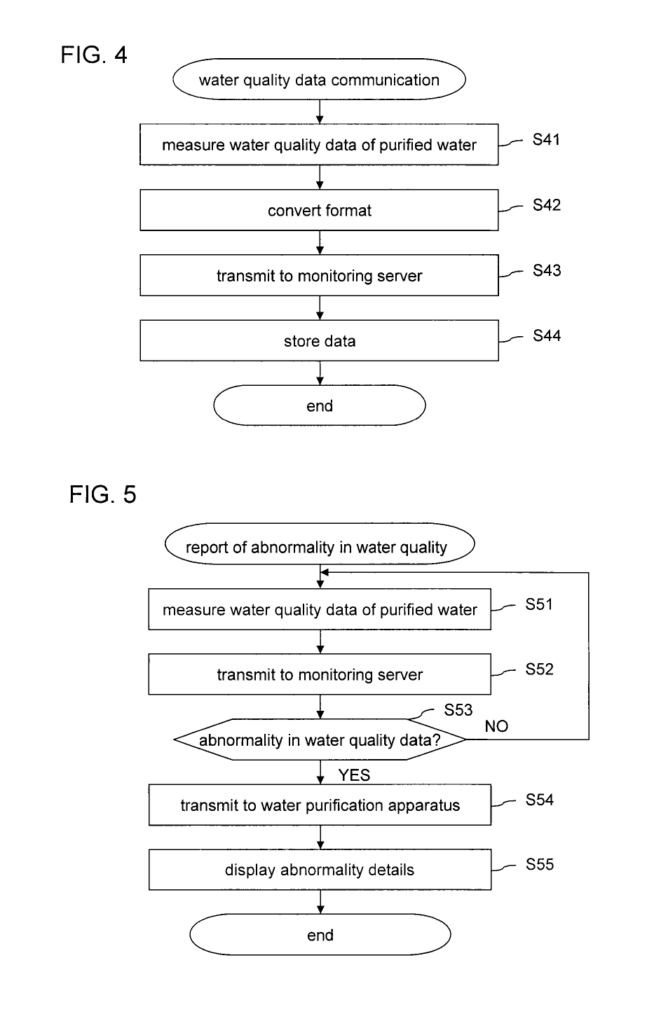

FIG. 4 is a flowchart of a water quality data communication process to be performed in the water purification system shown in FIG. 2.

In FIG. 4, first, water quality sensor 21 measures water quality data of purified water and transmits the data to controller 10 (step (S41)). Controller 10 converts the received water quality data to a specific format, for example, to a common format determined by service center 6 (step (S42)), and transmits the converted water quality data to controller 12 of monitoring server 7 (step (S43)).

Next, controller 12 stores in the database the received water quality data in a specific format (step (S44)), completing the present process.

According to the process shown in FIG. 4, since the water quality data of purified water in water purification apparatus 5 are transmitted to controller 12 of monitoring server 7, monitoring personnel at monitoring center 6 can monitor the water quality of purified water without going where water purification apparatus 5 is installed. Thus, the workload on monitoring personnel is reduced when monitoring the water quality of purified water.

In addition, in the process shown in FIG. 4, since water quality data are stored in the database after being converted to a specific format, it is easy to compare stored water quality data, reducing the workload on monitoring personnel when determining abnormality in the water quality of purified water. Also, by using stored data when determining abnormality in the water quality of purified water, abnormality in water quality can be determined highly accurately.

FIG. 5 is a flowchart showing a process to be performed for reporting abnormality in water quality in the water purification system shown in FIG. 2.

In FIG. 5, first, water quality sensor 21 measures water quality data of purified water and transmits the data to controller 10 (step (S51)). Controller 10 converts the received water quality data to a specific format and transmits the data to controller 12 of monitoring server 7 (step (S52)).

Next, in step (S53), controller 12 compares the transmitted water quality data with water quality data stored in the database to determine whether or not the transmitted water quality data are abnormal, and further determines details of the abnormality occurring in water purification apparatus 5 when the water quality data are found to be abnormal. A method for determining abnormality details is as follows, for example: By referring to operating logs of water quality data stored in the database of water purification apparatus 5, the details of the abnormality described in the operating log of such data that correspond to the transmitted water quality data are determined to be the details of the abnormality which is currently occurring in water purification apparatus 5.

As a result of the determination in step (S53), when water quality data are found not to be abnormal (NO in step (S53)), the process is returned to step (S51), and when water quality data are found to be abnormal (YES in step (S53)), the determined abnormality details are transmitted to controller 10 of water purification apparatus 5 (step (S54)), and controller 10 sends a command to display 11 to display the received abnormality details (step (S55)), thus completing the present process.

According to the process in FIG. 5, whether or not water quality data are abnormal is determined based on the water quality data transmitted from water purification apparatus 5 to monitoring center 6. When water quality data are found to be abnormal, the determined abnormality details are transmitted from monitoring center 6 to water purification apparatus 5 and are displayed on display 11. Thus, users of the water purification system are not required to send monitoring personnel to the place where water purification apparatus 5 is installed to find out whether or not water quality data are abnormal. Also, since details of the abnormality occurring in water purification apparatus 5 are determined based on the water quality data measured by water quality sensor 21, users of the water purification system are not required to analyze water purification apparatus 5 to know details of the abnormality. Here, when the water quality data are found not to be abnormal, the process is then repeated to determine whether or not the water quality data of purified water are abnormal (steps (S51) through (S53)).

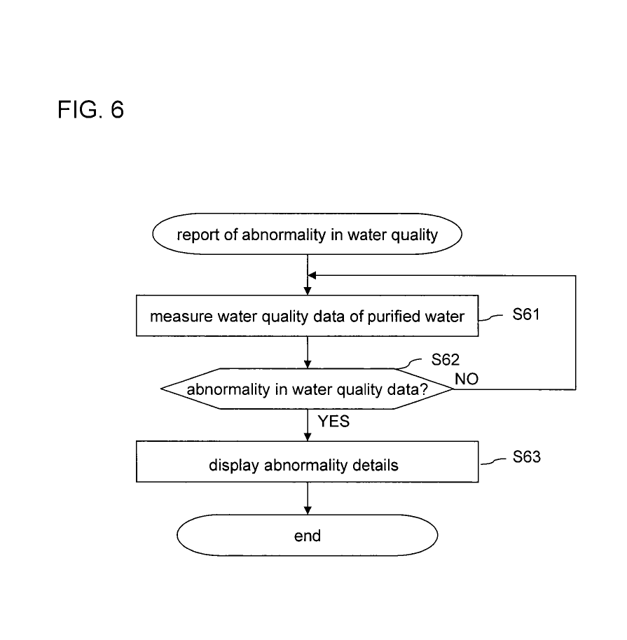

FIG. 6 is a flowchart of a modified example showing a process to be performed for reporting abnormality in water quality in the water purification system shown in FIG. 2. In such a process, no communication is conducted between water purification apparatus 5 and monitoring server 7.

First, in FIG. 6, water quality sensor 21 measures the water quality data of purified water and transmits the data to controller 10 (step (S61)). Controller 10 compares the received water quality data with reference water quality data stored in a memory of controller 10 (not shown in the drawings) to determine whether or not the transmitted water quality data are abnormal, then controller 10 further determines details of the abnormality when the water quality data are found to be abnormal (step (S62)).

As a result of the determination in step (S62), when water quality data are found not to be abnormal (NO in step (S62)), the process returns to step (S61), and when water quality data are found to be abnormal (YES in step (S62)), controller 10 sends a command to display 11 to display the determined abnormality details (step (S63)), thus completing the present process.

The process in FIG. 6 has the same effects as those in the process in FIG. 5. However, since water quality data are not stored in monitoring server 7 and users of the water purification system may not be able to receive high levels of service from monitoring center 6, the process in FIG. 6 is preferred to apply only to such abnormality that requires simple service.

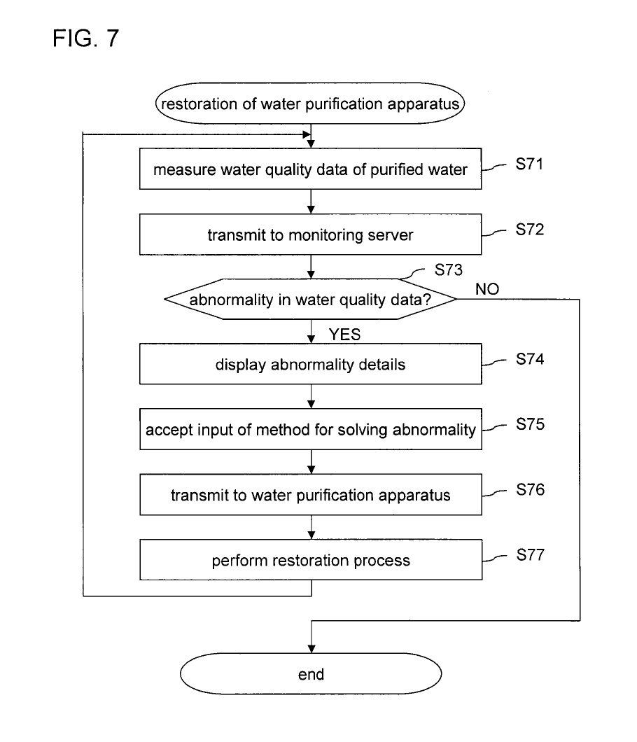

FIG. 7 is a flowchart showing a restoration process to be performed on the water purification apparatus in the water purification system shown in FIG. 2.

In FIG. 7, first, water quality sensor 21 measures water quality data of purified water and transmits the data to controller 10 (step (S71)). Controller 10 converts the received water quality data to a specific format and transmits the data to controller 12 of monitoring server 7 (step (S72)).

Next, in step (S73), controller 12 compares the transmitted water quality data with water quality data stored in the database to determine whether or not the transmitted water quality data are abnormal, and further determines details of the abnormality occurring in water purification apparatus 5 when the water quality data are found to be abnormal.

As a result of the determination in step (S73), when water quality data are found not to be abnormal (NO in step (S73)), the process is completed. When the water quality data are found to be abnormal (YES in step (S73)), controller 12 sends a command to display 13 to display the determined abnormality details (step (S74)).

Next, display 13 accepts input by monitoring personnel, who confirm the displayed abnormality details, as a method for solving the abnormality occurring in water purification apparatus 5 (step (S75)). Controller 12 transmits the received solving method to controller 10 of water purification apparatus 5 (step (S76)), controller 10 of water purification apparatus 5 performs a restoration process according to the received solving method (step (S77)), and the process returns to step (S71)).

According to the process shown in FIG. 7, based on the water quality data transmitted from water purification apparatus 5 to monitoring center 6, a method for solving the abnormality occurring in water purification apparatus 5 is input by monitoring personnel, and the method is transmitted to water purification apparatus 5 to be performed. Thus, monitoring personnel at monitoring center 6 are not required to go where water purification apparatus 5 is installed to perform a restoration process on water purification apparatus 5, reducing the duration for which purified water with abnormal water quality is supplied in the water purification system. Also, since monitoring personnel who confirm the abnormality details input a solving method, an appropriate solving method reflecting the knowledge of the monitoring personnel is implemented as a restoration process.

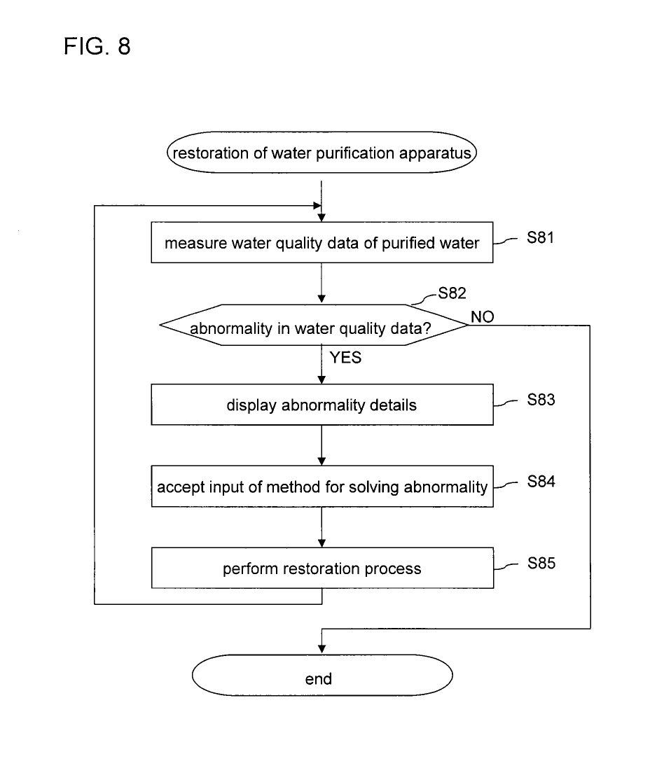

FIG. 8 is a flowchart of a modified example showing a restoration process to be performed on the water purification apparatus in the water purification system shown in FIG. 2. In such a process, no communication is conducted between water purification apparatus 5 and monitoring server 7, and no advice from monitoring service 6 is available. Thus, such a process requires users of the water purification system to have knowledge of a method for solving the abnormality occurring in water purification apparatus 5.

In FIG. 8, first, water quality sensor 21 measures the water quality data of purified water and transmits the data to controller 10 (step (S81)). Controller 10 compares the received water quality data with reference water quality data stored in the memory of controller 10 to determine whether or not the transmitted water quality data are abnormal (step (S82)).

As a result of the determination in step (S82), when water quality data are found not to be abnormal (NO in step (S82)), the present process is completed, and when the water quality data are found to be abnormal (YES in step (S82)), controller 10 sends a command to display 11 to display the determined abnormality details (step (S83)).

Next, display 11 accepts input by the user, who has confirmed the displayed abnormality details, as a method for solving the abnormality occurring in water purification apparatus 5 (step (S84)), controller 10 performs the restoration process according to the received solving method (step (S85)), and the process returns to step (S81).

According to the process shown in FIG. 8, controller 10 performs a restoration process while no communication is conducted between water purification apparatus 5 and monitoring server 7. Thus, water purification apparatus 5 is restored at an early stage.

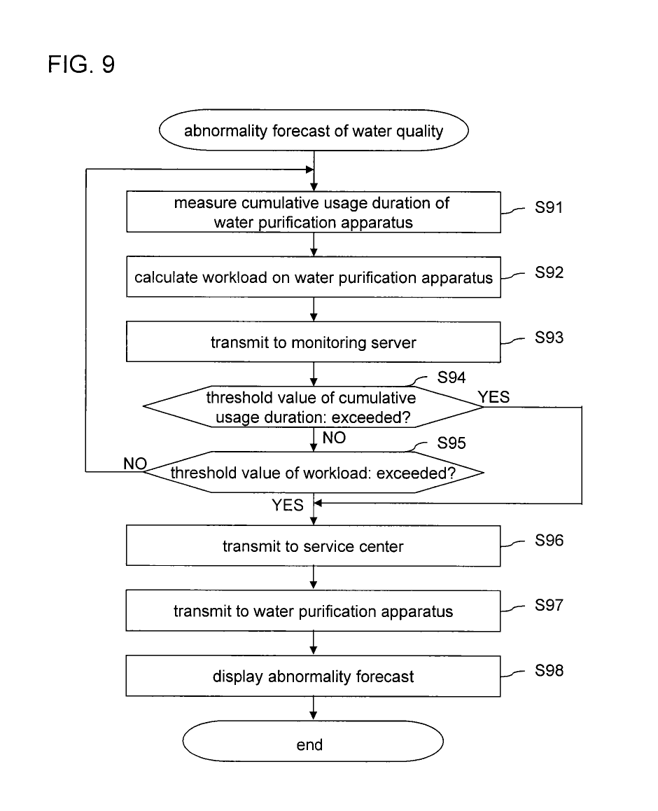

FIG. 9 is a flowchart showing a process to be performed for forecasting abnormality in water quality in the water purification system shown in FIG. 2.

In FIG. 9, first, controller 10 of water purification apparatus 5 measures the cumulative usage duration of water purification apparatus 5 (step (S91)), and further calculates the workload on water purification apparatus 5 (step (S92)). Here, the workload on water purification apparatus 5 corresponds to the difference per unit time between the water quality of sewage flowing into inflow port 14 and the water quality of purified water supplied from outlet 15, more specifically, to the cumulative value of differences during the above usage duration between measured values of physical indicators of the water quality of sewage measured by water quality sensor 20 and measured values of physical indicators of the water quality of purified water measured by water quality sensor 21.

Next, controller 10 transmits to controller 12 of monitoring server 7 the measured cumulative usage duration of water purification apparatus 5 and the calculated workload on water purification apparatus 5 (step (S93)).

Next, in step (S94), controller 12 determines whether or not the transmitted cumulative usage duration of water purification apparatus 5 has exceeded the threshold value of cumulative usage duration stored in advance in the database. When the cumulative usage duration has not exceeded the threshold value (NO in step (S94), the process advances to step (S95), and when the cumulative usage duration has exceeded the threshold value (YES in step (S94)), the process skips step (S95) and advances to step (S96).

Next, in step (S95), controller 12 determines whether or not the transmitted workload on water purification apparatus 5 has exceeded the threshold value of the workload stored in advance in the database. When the cumulative workload has not exceeded the threshold value (NO in step (S95)), the process returns to step (S91). When the workload has exceeded the threshold value (YES in step (S95)), controller 12 transmits information that the cumulative usage duration has exceeded the threshold value, or the workload has exceeded the threshold value, to a service center where service engineers are available to provide required services (not shown in the drawings) (step (S96)), while transmitting such information to controller 10 of water purification apparatus 5 (step (S97)). Transmission to a service center may be conducted directly or through monitoring server 7.

Next, after receiving such information that the cumulative usage duration has exceeded the threshold value or the workload has exceeded the threshold value, controller 10 sends a command to display 11 to display an abnormality forecast as to when abnormality may occur in water purification apparatus 5 after a predetermined time and result in abnormality in the quality of purified water (step (S98)). The present process is completed.

According to the process shown in FIG. 9, when the cumulative usage duration of water purification apparatus 5 has exceeded the threshold value, or when the workload on water purification apparatus 5 has exceeded the threshold value, an abnormality forecast is displayed on display 11. Thus, users of the water purification system are informed in advance that abnormality may occur in water purification apparatus 5 after a predetermined time, and are able to prepare actions for the abnormality in water purification apparatus 5 accordingly. Here, as for such actions, for example, securing necessary purified water before the predetermined time elapses, switching the intended use of purified water supplied by water purification apparatus 5 to a use that requires lower quality, and the like may be listed.

Also, in the process shown in FIG. 9, when the cumulative usage duration has exceeded the threshold value, or when the workload has exceeded the threshold value, such information is transmitted to a service center. Thus, service engineers stationed at the service center are able to arrange in advance repair parts required for solving the abnormality in water purification apparatus 5, enabling the abnormality in water purification apparatus 5 to be solved at an early stage.

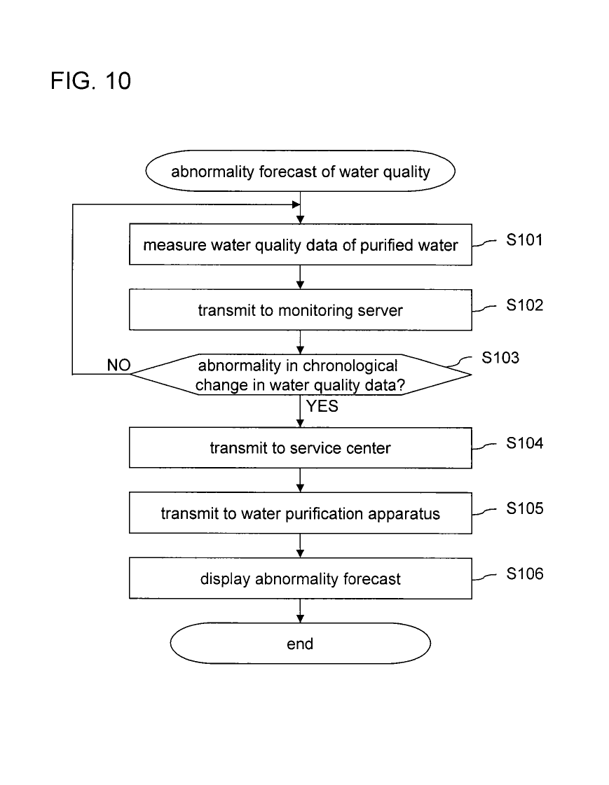

FIG. 10 is a flowchart of a modified example showing a process to be performed for forecasting abnormality in water quality in the water purification system shown in FIG. 2.

In FIG. 10, first, water quality sensor 21 measures the water quality data of purified water and transmits the data to controller 10 (step (S101)). Controller 10 converts the received water quality data to a specific format and transmits the data to controller 12 of monitoring server 7 (step (S102)).

Next, in step (S103), controller 12 monitors chronological changes in water quality data based on the currently transmitted water quality data and old water quality data transmitted earlier so as to determine whether or not chronological changes in water quality data show abnormality. Here, abnormality in chronological changes in water quality data means, for example, situations where a declining rate of water quality per unit time dips under the threshold value.

As a result of the determination in step (S103), when no abnormality is found in chronological changes in water quality data (NO in step (S103)), the process returns to step (S101), and when abnormality is found in chronological changes in water quality data (YES in step (S103)), such information that abnormality is found in the chronological changes in water quality data is transmitted to a service center (not shown in the drawings) (step (S104)) and to controller 10 of water purification apparatus 5 (step (S105)).

Next, when receiving such information that abnormality is found in the chronological changes in water quality data, controller 10 sends a command to display 11 to display an abnormality forecast that abnormality may occur in water purification apparatus 5 after a predetermined time and result in abnormality in the water quality of purified water (step (S106)). Accordingly, the present process is completed.

According to the process shown in FIG. 10, when abnormality is found in chronological changes in water quality data, such information that abnormality is found in chronological changes in water quality data is transmitted to a service center and an abnormality forecast is displayed on display 11. Thus, service engineers stationed at the service center and users of the water purification system are informed in advance that abnormality may occur in water purification apparatus 5 after a predetermined time.

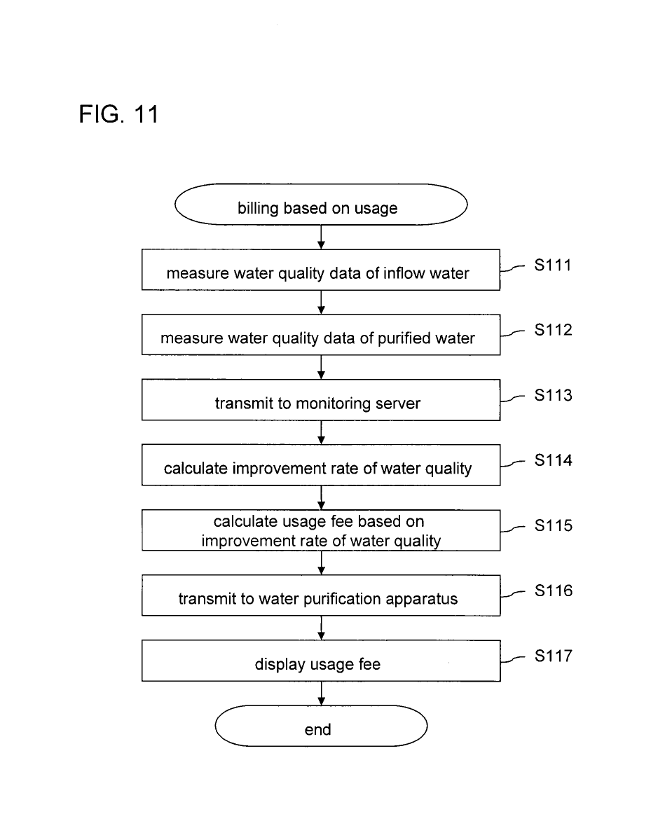

FIG. 11 is a flowchart showing a usage-based billing process to be performed in the water purification system shown in FIG. 2.

In FIG. 11, first, water quality sensor 20 measures water quality data of inflow water such as sewage and transmits the data to controller 10 (step (S111)), and water quality sensor 21 measures water quality data of purified water and transmits the data to controller 10 (step (S112)). Controller 10 converts the received water quality data of the inflow water and purified water to a specific format and transmits those data to controller 12 of monitoring server 7 (step (S113)).

Next, based on the transmitted water quality data of the inflow water and purified water, controller 12 calculates the improvement rate of water quality, for example, the difference between the water quality data of the inflow water and the water quality data of the purified water (step (S114)), and calculates usage fees for the water purification system according to the calculated improvement rate of water quality (step (S115)). When calculating usage fees for the water purification system, controller 12 refers to a chart of usage fees corresponding to improvement rates of water quality stored beforehand in the database and searches for usage fees corresponding to calculated improvement rates of water quality. Here, usage fees are set higher for higher improvement rates in the chart.

Next, controller 12 transmits calculated usage fees to controller 10 of water purification apparatus 5 (step (S116)), and controller 10 sends a command to display 11 to display the received usage fees (step (S117)). Accordingly, the present process is completed.

According to the process shown in FIG. 11, usage fees for the water purification system are calculated according to improvement rates of water quality corresponding to differences between the water quality data of water flowing into water purification apparatus 5 and the water quality data of purified water supplied by water purification apparatus 5. Thus, water quality data of purified water provided to users are reflected in usage fees for the water purification system, giving the users incentives for using the water purification system. Specifically, since usage fees are set according to the difference between the water quality data of inflow water and the water quality data of purified water, usage fees for the water purification system correspond to improvement rates of water quality, making the usage fees for the water purification system even more appropriate for users.

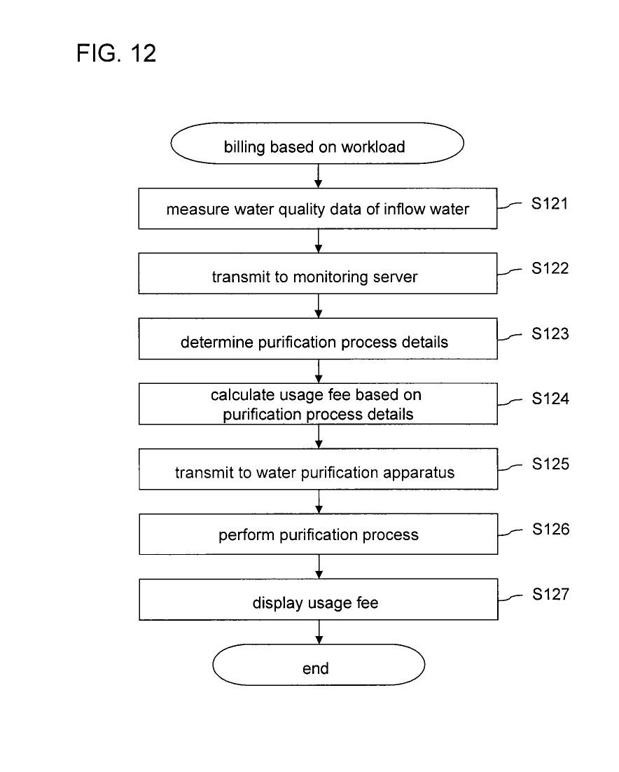

FIG. 12 is a flowchart showing a workload-based billing process to be performed by the water purification system shown in FIG. 2.

In FIG. 12, first, water quality sensor 20 measures water quality data of inflow water such as sewage and transmits the data to controller 10 (step (S121). Controller 10 converts the received water quality data of the inflow water to a specific format and transmits the data to controller 12 of monitoring server 7 (step (S122)).

Next, based on the transmitted water quality data of inflow water, controller 12 determines details of the purification process to be performed in water purification apparatus 5 (step (S123)). For example, if the quality of inflow water is high, only a filtration process by filtration filter 19 is determined to be performed; if the quality of inflow water is in a middle range, a decomposition process using supercritical water or subcritical water is determined to be performed along with a filtration process by filtration filter 19; and if the quality of inflow water is low, a sterilization process by a photocatalyst is determined to be performed along with a filtration process by filtration filter 19 and a decomposition process using supercritical water or subcritical water.

Next, controller 12 calculates usage fees for the water purification system according to details of the water purification process performed in water purification apparatus 5 (step (S124)). Usage fees for the water purification system are set higher as the number of purification procedures determined to be performed in step (S123) increases, namely, the usage fees are set higher as the workload on water purification apparatus 5 increases. For example, when the quality of purified water required by a user of the water purification system is constant, the types of purification procedures to be performed will increase as the quality of inflow water decreases. Thus, usage fees for the water purification system are set higher for inflow water with lower quality.

Next, controller 12 transmits the calculated usage fees and details of the determined purification procedures to controller 10 of water purification apparatus 5 (step (S125)). Controller 10 performs the purification process corresponding to the received details of purification process (step (S126)), and sends a command to display 11 to display the received usage fees (step (S127)), thus completing the present process.

According to the process shown in FIG. 12, usage fees for the water purification system are calculated based on details of the purification process performed by water purification apparatus 5, namely, based on the workload on water purification apparatus 5. Thus, usage fees for the water purification system are also set appropriately for the provider of the water purification system.

In addition, in the process shown in FIG. 12, billing rates increase as the quality of inflow water decreases. Usually, the lower the quality of inflow water, the higher the workload on water purification apparatus 5. Therefore, usage fees for the water purification system correspond to the workload on water purification apparatus 5.

In the process shown in FIG. 12 above, controller 12 of monitoring server 7 calculates usage fees for the water purification system based on the workload on water purification apparatus 5. However, it is also an option for controller 10 of water purification apparatus 5 to determine details of a purification process to be performed and to calculate usage fees for the water purification system based on the workload on water purification apparatus 5.

In the above-described water purification system of the present embodiment, when the quality of purified water decreases due to abnormality in water purification apparatus 5, usage fees for the water purification system are preferred to be reduced after the quality of purified water has lowered. Accordingly, usage fees for the water purification system are set even more appropriately for users.

Also, in the above-described water purification system of the present embodiment, if water purification apparatus 5 cannot be used when abnormality has occurred, usage fees for the water purification system are preferred to be reduced in accordance with the duration for which water purification apparatus 5 cannot be used. In doing so, usage fees for the water purification system are set to correspond to the inconvenience to the users.

Moreover, in the above-described water purification system of the present embodiment, usage fees are preferred to be reduced in accordance with the water leakage rate in water purification apparatus 5. In doing so, unfair billing of usage fees for the water purification system is prevented.

In the above-described water purification system of the present embodiment, quality or the like of purified water provided by water purification apparatus 5 is preferred to be constantly reported to display 11 by controller 10 of water purification apparatus 5. In doing so, user satisfaction will increase when using the water purification system.

A computer or the like may be provided with a memory medium with a stored software program for implementing the functions of the above-described embodiment, and then the CPU of the computer reads and runs the program stored in the memory medium.

In such a case, since the functions in the above-described embodiment are implemented by the program itself read from the memory medium, the program and a memory medium with the stored program form the present invention.

As for memory media to provide programs, for example, the following media that can store above programs are sufficient: RAM, NV-RAM, floppy (registered trade mark) disc, hard disc, magneto-optical disc, optical discs such as CD-ROM, CD-R, CD-RW and DVD (DVD-ROM, DVD-RAM, DVD-RW, DVD+RW), magnetic tapes, nonvolatile memory cards and other ROMs. Alternatively, the above programs may also be provided to a computer by downloading from other computers, databases or the like connected to the Internet, commercial networks, local area networks (not shown in the drawings), etc.

Also, in addition to implementing the functions of the above-described embodiment by running a program read by the CPU of a computer, it is also an option for the OS (operating system) or the like on the CPU to run some or all of the actual procedures according to the commands of the program so that the functions of the above-described embodiment are implemented through such procedures.

Moreover, it is another option for a program read from the memory medium to be written on the memory of an expansion board inserted into a computer or of an expansion unit connected to the computer, and for the CPU or the like in the expansion board or the expansion unit to run some or all of the actual procedures according to the commands of the program so that the functions of the above-described embodiment are implemented.

The above programs may also be those that are run by object codes and interpreters, script data provided to the OS, or the like.

In a conventional water purification system, only the amount of purified water is billed, and usage fees for a water purification system are determined without reflecting the quality of purified water supplied to users. Accordingly, usage fees for a water purification system do not always correspond to the degree of user satisfaction, and do not give incentives to users of the water purification system.

According to an embodiment of the present invention, a billing method for use of a water purification system gives incentives for using the water purification system.

A billing method for use of a water purification system according to an embodiment of the present invention is equipped at least with a water purification apparatus, a control apparatus and a water quality sensor. The control apparatus is featured with a billing method based on the difference between the quality of water flowing into the water purification apparatus and the quality of purified water supplied by the water purification apparatus.

In an embodiment of the present invention, the control apparatus is preferred to bill based on the workload on the water purification apparatus.

In an embodiment of the present invention, the control apparatus is preferred to raise billing rates as the quality of inflow water decreases.

In an embodiment of the present invention, the control apparatus is preferred to lower billing rates after the quality of purified water has lowered.

In an embodiment of the present invention, the control apparatus is preferred to lower billing rates in accordance with the duration for which the water purification apparatus cannot be used.

In an embodiment of the present invention, the control apparatus is preferred to lower billing rates in accordance with the rate of water leakage in the water purification apparatus.

In an embodiment of the present invention, the control apparatus is preferred to bill based on details of the restoration process conducted when the water purification apparatus is restored.

In the control apparatus according to an embodiment of the present invention, the water purification system is further equipped with a monitoring apparatus which is connected to, and capable of communicating with, the water purification apparatus via public networks, and the monitoring apparatus is preferred to include the control apparatus.

In an embodiment of the present invention, the water purification apparatus is preferred to be equipped with the control apparatus.

According to an embodiment of the present invention, usage fees for the water purification system are calculated based on the details of the purification process performed in the water purification apparatus, namely, based on the workload on the water purification apparatus. Therefore, usage fees for the water purification system are also set appropriately for the provider of the water purification system. In addition, billing rates are raised as the quality of inflow water decreases. Usually, the lower the quality of inflow water, the higher the workload on a water purification apparatus. Thus, usage fees for the water purification system are set corresponding to the workload on the water purification apparatus.

Obviously, numerous modifications and variations of the present invention are possible in light of the above teachings. It is therefore to be understood that within the scope of the appended claims, the invention may be practiced otherwise than as specifically described herein.

1-9. (canceled)

10. A method for calculating a bill for a water purification system, comprising:
measuring water quality of inflow water prior to flowing the inflow water through a water purification apparatus;
measuring water quality of purified water obtained by flowing the inflow water through the water purification apparatus;
selecting at least one purification process among a plurality of purification processes based on difference between the water quality of the inflow water before the water purification apparatus and the water quality of the purified water obtained by flowing the inflow water through the water purification apparatus; and
determining a usage fee for the water purification system based on the purification process selected based on the difference between the water quality of the inflow water before the water purification apparatus and the water quality of the purified water obtained by flowing the inflow water through the water purification apparatus,
wherein the water purification apparatus is configured to perform the plurality of purification processes.

11. The method for calculating a bill for a water purification system according to claim 10, wherein the measuring of the water quality of the inflow water comprises measuring of the water quality of the inflow water by a first water quality sensor, and the measuring of the water quality of the purified water comprises measuring of the water quality of the purified water by a second water quality sensor.

12. The method for calculating a bill for a water purification system according to claim 10, further comprising monitoring workload of the water purification apparatus by a control apparatus which controls operation of the water purification apparatus, wherein the control apparatus controls the selecting of the purification process, and the determining of the usage fee comprises calculating the usage fee based on the workload of the water purification apparatus determined by the control apparatus.

13. The method for calculating a bill for a water purification system according to claim 12, wherein the control apparatus raises a billing rate as the quality of the inflow water decreases.

14. The method for calculating a bill for a water purification system according to claim 12, wherein the control apparatus lowers a billing rate after the quality of the purified water has decreased.

15. The method for calculating a bill for a water purification system according to claim 12, wherein the control apparatus lowers a billing rate in accordance with duration for which the water purification apparatus is not in operation.

16. The method for calculating a bill for a water purification system according to claim 12, wherein the control apparatus lowers a billing rate in accordance with a water leakage rate of the water purification apparatus.

17. The method for calculating a bill for a water purification system according to claim 12, wherein the control apparatus calculates the usage fee according to a restoration process performed in the water purification apparatus.

18. The method for calculating a bill for a water purification system according to claim 10, wherein the water purification apparatus is connected to a monitoring apparatus which communicates via a public network, and the monitoring apparatus comprises the control apparatus.

19. The method for calculating a bill for a water purification system according to claim 12, wherein the water purification apparatus comprises the control apparatus.

20. The method for calculating a bill for a water purification system according to claim 12, further comprises combining a plurality of purification processes selected by the control apparatus based on the difference between the water quality of the inflow water before the water purification apparatus and the water quality of the purified water obtained by flowing the inflow water through the water purification apparatus, wherein the determining of the usage fees comprises determining the usage fee for the water purification system based on the purification processes selected and combined based on the difference between the water quality of the inflow water before the water purification apparatus and the water quality of the purified water obtained by flowing the inflow water through the water purification apparatus.

21. A method for calculating a bill for a water purification system, comprising:
measuring water quality of inflow water prior to flowing the inflow water through a water purification apparatus;
measuring water quality of purified water obtained by flowing the inflow water through the water purification apparatus;
collecting water quality data of the inflow water based on the water quality of the inflow water;
collecting water quality data of the purified water based on the water quality of the purified water;
calculating an improvement rate of the water quality of the inflow water with respect to the water quality of the purified water based on the water quality data of the inflow water and the water quality data of the purified water; and
calculating a usage fee for the water purification system based on the improvement rate of the water quality of the inflow water with respect to the water quality of the purified water.

22. The method for calculating a bill for a water purification system according to claim 21, wherein the water purification apparatus comprises a filtration filter, a first water quality sensor positioned to measure the water quality of the inflow water flowing into the water purification apparatus, and a second water quality sensor positioned to measure the water quality of the purified water obtained through the filtration filter, and a monitoring device is connected to the water purification apparatus via a public network and collects the water quality data of the inflow water based on the water quality of the inflow water, collect the water quality data of the purified water based on the water quality of the purified water, calculate the improvement rate of the water quality of the inflow water with respect to the water quality of the purified water based on the water quality data of the inflow water and the water quality data of the purified water, and calculate the usage fee for the water purification system based on the improvement rate of the water quality of the inflow water with respect to the water quality of the purified water.

23. The method for calculating a bill for a water purification system according to claim 21, further comprising monitoring workload of the water purification apparatus by a control apparatus which controls operation of the water purification apparatus, wherein the determining of the usage fee comprises calculating the usage fee based on the workload of the water purification apparatus determined by the control apparatus.

24. The method for calculating a bill for a water purification system according to claim 23, wherein the control apparatus raises a billing rate as the quality of the inflow water decreases.

25. The method for calculating a bill for a water purification system according to claim 23, wherein the control apparatus lowers a billing rate after the quality of the purified water has decreased.

26. The method for calculating a bill for a water purification system according to claim 23, wherein the control apparatus lowers a billing rate in accordance with duration for which the water purification apparatus is not in operation.

27. The method for calculating a bill for a water purification system according to claim 23, wherein the control apparatus lowers a billing rate in accordance with a water leakage rate of the water purification apparatus.

28. A water purification system comprising:
a water purification apparatus configured to perform a plurality of purification processes and comprising a filtration filter, a first water quality sensor positioned to measure water quality of inflow water flowing into the water purification apparatus, and a second water quality sensor positioned to measure water quality of purified water obtained through the filtration filter; and
a monitoring device connected to the water purification apparatus via a public network and configured to collect water quality data of the inflow water based on the water quality of the inflow water, collect water quality data of the purified water based on the water quality of the purified water, calculate an improvement rate of the water quality of the inflow water with respect to the water quality of the purified water based on the water quality data of the inflow water and the water quality data of the purified water, and calculate a usage fee for the water purification system based on the improvement rate of the water quality of the inflow water with respect to the water quality of the purified water.

29. The water purification system according to claim 28, wherein the water purification apparatus includes a control device configured to select at least one purification process among the plurality of purification processes based on difference between the water quality of the inflow water before the water purification apparatus and the water quality of the purified water obtained by flowing the inflow water through the water purification apparatus and to monitor workload of the water purification apparatus, and the monitoring device is configured to calculate the usage fee based on the workload of the water purification apparatus determined by the control apparatus.
